(19) United States
(12) Patent Application Publication
(10) Pub. No.: US 2025/0211130 A1
(43) Pub. Date: Jun. 26, 2025

(54) POWER CONVERSION DEVICE

(71) Applicant: Panasonic Automotive Systems Co., Ltd., Kanagawa (JP)

(72) Inventor: Takehiro YAMAZAKI, Tokyo (JP)

(21) Appl. No.: 18/954,149

(22) Filed: Nov. 20, 2024

(30) Foreign Application Priority Data
Dec. 26, 2023 (JP) 2023-218861

(51) Int. Cl. H02M 7/219; B60L 53/20; H02M 1/084; H02M 1/088; H02M 1/34

(52) U.S. Cl. CPC H02M 7/219; B60L 53/20; H02M 1/084; H02M 1/088; H02M 1/346

(57) ABSTRACT

In a power conversion device, multiple power semiconductor devices include a first pair of power semiconductor devices and a second pair of power semiconductor devices. The first pair corresponds to a specific phase of a multi-phase AC power supply. The second pair corresponds to another phase. A relay circuit switches a connection destination of the second pair between the specific phase and the other phase. When a single-phase AC power supply is connected to the power conversion device, a control circuit turns on a predetermined one or more of the multiple power semiconductor devices, and detects a zero-crossing point of a power supply voltage of the single-phase AC power supply based on a voltage between contact points of the relay circuit. The control circuit switches a connection destination of the second pair to the specific phase by operating the relay circuit within a zero period following the zero-crossing point.

### CROSS-REFERENCE TO RELATED APPLICATIONS

This application is based upon and claims the benefit of priority from Japanese Patent Application No. 2023-218861, filed Dec. 26, 2023, the entire contents of which are incorporated herein by reference.

### FIELD

The present disclosure relates generally to a power conversion device.

### BACKGROUND

A power conversion device such as an in-vehicle charger that can operate by accepting an input of an AC voltage from each of a three-phase AC power supply and a single-phase AC power supply has been known (for example, a patent literature JP 2021-164166 A).

Such a power conversion device includes, for example, power conversion circuits respectively corresponding to phases of an AC power supply, and a relay circuit that switches connection destinations of the power conversion circuits between a phase of the AC power supply corresponding to each of the power conversion circuits and a phase common to the power conversion circuits.

For such a power conversion device, in order to inhibit an inrush current generated in the relay circuit during phase switching of the input AC power supply, there is a known technique for operating the relay circuit at a zero-crossing point of the AC power supply at which a voltage between contact points of the relay circuit becomes zero.

However, there has been a case where a connection destination of a relay circuit is switched at a timing deviated from a zero-crossing point due to a variation in a circuit and a component, a change in an external environment, or the zero-crossing point being an instantaneous timing. Therefore, there is room for improvement with regard to inhibition of an inrush current generated in a relay circuit during phase switching of an input AC power supply.

### SUMMARY

A power conversion device according to one aspect of the present disclosure includes a plurality of terminals, a power conversion circuit, a phase switching circuit, and, a control circuit. To the plurality of terminals, a single-phase AC power supply or a multi-phase AC power supply is connected as an external power supply. The power conversion circuit includes multiple power semiconductor devices. The multiple power semiconductor devices include a first pair of power semiconductor devices and a second pair of power semiconductor devices. The first pair of power semiconductor devices corresponds to a specific phase of the multiple phases of the multi-phase AC power supply. The second pair of power semiconductor devices corresponds to another phase different from the specific phase of the multiple phases. The phase switching circuit includes a relay circuit that is configured to switch a connection destination of the second pair of power semiconductor devices between the specific phase and the other phase. The control circuit is configured to control operations of the power conversion circuit and the phase switching circuit. The control is performed by, when the single-phase AC power supply is connected to the terminals, turning on a predetermined power semiconductor device among the multiple power semiconductor devices, and detecting a zero-crossing point at which a power supply voltage from the single-phase AC power supply zero-crosses in a state where the predetermined power semiconductor device is turned on. The zero-crossing point is detected based on a voltage between contact points of the relay circuit. Then, the control is performed by switching a connection destination of the second pair of power semiconductor devices to the specific phase by operating the relay circuit within a zero period following the zero-crossing point.

### BRIEF DESCRIPTION OF THE DRAWINGS

FIG. 1 is a diagram schematically illustrating an example of a configuration of a charging system including a power conversion device according to an embodiment;

FIG. 2 is a diagram illustrating an example of a configuration of the power conversion device of FIG. 1;

FIG. 3 is a flowchart illustrating an example of a procedure of control processing performed by the control circuit of FIG. 2; and

FIG. 4 is a timing chart illustrating an operation timing of each unit of the power conversion device by the control circuit of FIG. 2.

### DETAILED DESCRIPTION

Hereinafter, embodiments of a power conversion device, a vehicle, a control method for the power conversion device, a program, and a recording medium according to the present disclosure will be described with reference to the drawings.

In the description of the present disclosure, components that have the same or substantially the same functions as those described above in the previously described drawings are denoted by the same reference numerals, and the description thereof may be appropriately omitted. Even when the same or substantially the same portions are denoted by the same reference numerals, dimensions and ratios may be represented differently from each other in the drawings. From the viewpoint of ensuring visibility of the drawings, in the description of each drawing, only main components are denoted by reference numerals, and even components that have the same or substantially the same functions as those described above in the previous drawings may not be denoted by reference numerals.

In the description of the present disclosure, components having the same or substantially the same function may be distinguished and described by adding alphanumeric characters to the ends of reference numerals. When components that have the same or substantially the same functions are not distinguished from each other, the components may be described integrally by omitting alphanumeric characters added to the ends of the reference numerals.

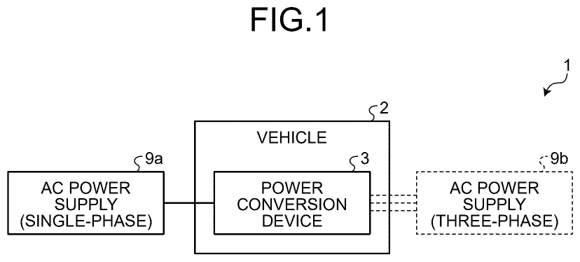

FIG. 1 is a diagram schematically illustrating an example of a configuration of a charging system 1 including a power conversion device 3 according to an embodiment. The charging system 1 exemplified in FIG. 1 includes a single-phase AC power supply 9a or a three-phase AC power supply 9b, and a vehicle 2 in which the power conversion device 3 is provided.

In one example, the power conversion device 3 according to the embodiment may be provided as an in-vehicle charger in the vehicle 2. The power conversion device 3 may be an in-vehicle charger that converts AC power supplied from the external single-phase AC power supply 9a or the three-phase AC power supply 9b into DC power, and supplies the DC power to a battery (not illustrated) provided in the vehicle 2. In other words, the power conversion device 3 according to the embodiment may be provided in the vehicle 2 along with the battery and may be implemented as an in-vehicle charger that supplies power to the battery of the vehicle 2 by using AC power from the external single-phase AC power supply 9a or three-phase AC power supply 9b.

The power conversion device 3 according to the embodiment is not limited to the vehicle 2, and may be provided in, for example, an aircraft, a game facility, an uninterruptible power conversion circuit, or the like.

Any of various moving bodies can be appropriately used as the vehicle 2. Examples of the various moving bodies include, for example, a passenger car, a cargo vehicle, a passenger van, a motorcycle, and an electrical scooter, which are configured to drive by using electrical power from the battery or drive equipped components (electrical components). Examples of the electrical components may include a navigation device, an audio device, an air conditioner, a power window, a defogger, an electronic control unit (ECU), a global positioning system (GPS) module, and an in-vehicle camera. As the battery of the vehicle 2, any battery such as a lithium ion battery, a nickel hydrogen battery, or an all-solid-state battery can be appropriately used as long as electrical power for driving a traveling motor (main motor), electrical components, and the like provided in the vehicle 2 can be stored.

The single-phase AC power supply 9a and the three-phase AC power supply 9b are each an optional external power supply such as a general-purpose power supply and a commercial power supply provided in, for example, a quick charging facility. The AC power supply 9 is not limited to a single-phase AC power supply and a three-phase AC power supply (multi-phase AC power supply), and a two-phase AC power supply (multi-phase AC power supply) may be used. In the present embodiment, a case where the single-phase AC power supply 9a and the three-phase AC power supply 9b are available as the AC power supply 9 that supplies AC power to the power conversion device 3 will be exemplified. Thus, in the present embodiment, the power conversion device 3 configured to be operable regardless of whether the AC power is input from the single-phase AC power supply 9a or the AC power is input from the three-phase AC power supply 9b is exemplified.

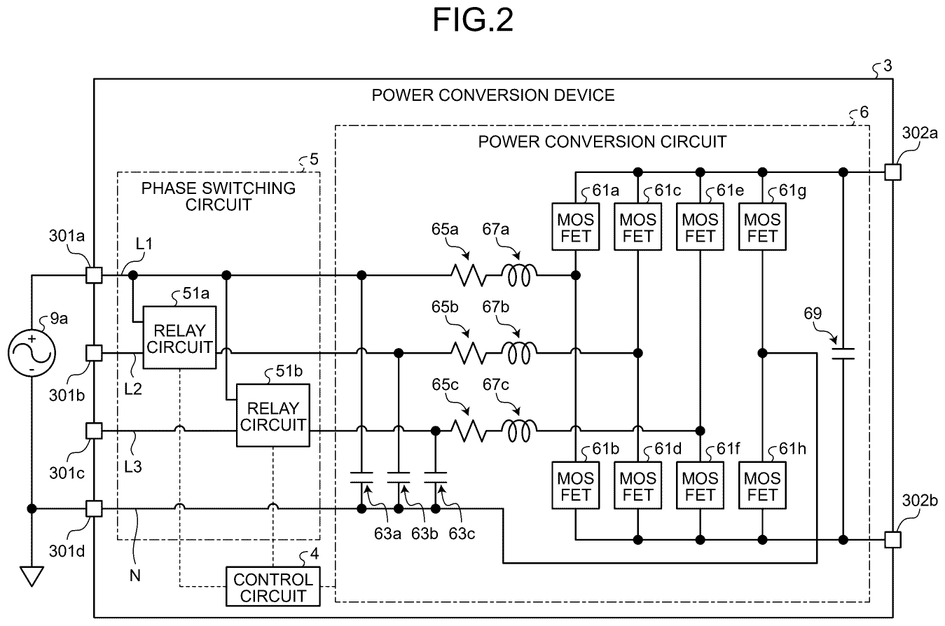

FIG. 2 is a diagram illustrating an example of a configuration of the power conversion device 3 of FIG. 1.

As illustrated in FIG. 2, the power conversion device 3 includes a plurality of input terminals 301a to 301d to which an external power supply is connected. Note that FIG. 2 illustrates a case where the single-phase AC power supply 9a is connected as an external power supply to the power conversion device 3. The power conversion device 3 includes a pair of output terminals 302a and 302b to which a load such as an in-vehicle battery (not illustrated) is connected.

The input terminal 301a is connected to one end of the single-phase AC power supply 9a. In the power conversion device 3, a power supply line L1 through which a single-phase current from the single-phase AC power supply 9a flows is electrically connected to the input terminal 301a. When the three-phase AC power supply 9b is connected as an external power supply to the power conversion device 3, the power supply line L1 is an electrical wire through which, for example, a U-phase (the first phase) current from the three-phase AC power supply 9b flows.

The input terminal 301b is not connected to the single-phase AC power supply 9a. In the power conversion device 3, a power supply line L2 through which a single-phase current from the single-phase AC power supply 9a flows via a relay circuit 51a is electrically connected to the input terminal 301b. When the three-phase AC power supply 9b is connected as an external power supply to the power conversion device 3, the power supply line L2 is an electrical wire through which, for example, a V-phase (the second phase) current from the three-phase AC power supply 9b flows.

The input terminal 301c is not connected to the single-phase AC power supply 9a. In the power conversion device 3, a power supply line L3 through which a single-phase current from the single-phase AC power supply 9a flows via a relay circuit 51b is electrically connected to the input terminal 301c. When the three-phase AC power supply 9b is connected as an external power supply to the power conversion device 3, the power supply line L3 is an electrical wire through which, for example, a W-phase (the third phase) current from the three-phase AC power supply 9b flows.

The input terminal 301d is electrically connected to the other end of the single-phase AC power supply 9a and a ground potential. Thus, the input terminal 301d is a ground terminal. In the power conversion device 3, a neutral power supply line N is electrically connected to the input terminal 301d.

As illustrated in FIG. 2, the power conversion device 3 includes a control circuit 4, a phase switching circuit 5, and a power conversion circuit 6.

The control circuit 4 is electrically connected to each of the phase switching circuit 5 and the power conversion circuit 6 via, for example, a signal line for a control signal. The phase switching circuit 5 is electrically connected to the input terminals 301a to 301d via the power supply lines L1 to L3 and N. The phase switching circuit 5 is electrically connected to the power conversion circuit 6 at a subsequent stage via the power supply lines L1 to L3 and N. The power conversion circuit 6 is electrically connected to a pair of output terminals 302a and 302b via a pair of output power supply lines.

The output power supply line electrically connected to the output terminal 302a is electrically connected to the power supply line L1 via a MOSFET 61a of the power conversion circuit 6, is electrically connected to the power supply line L2 via a MOSFET 61c, is electrically connected to the power supply line L3 via a MOSFET 61e, and is electrically connected to the power supply line N via a MOSFET 61g. Similarly, the output power supply line electrically connected to the output terminal 302b is electrically connected to the power supply line L1 via a MOSFET 61b of the power conversion circuit 6, is electrically connected to the power supply line L2 via a MOSFET 61d, is electrically connected to the power supply line L3 via a MOSFET 61f, and is electrically connected to the power supply line N via a MOSFET 61h.

The control circuit 4 is electrically connected to control ends of the two relay circuits 51a and 51b of the phase switching circuit 5 via signal lines for control signals. The control circuit 4 is electrically connected to a control end of each of the MOSFETs 61a to 61h of the power conversion circuit 6 via a signal line for a control signal.

The control circuit 4 includes at least one processor and at least one memory, and may have a hardware configuration using a normal computer.

As a processor of the control circuit 4, a central processing unit (CPU) can be used. The processor of the control circuit 4 executes a computer program to integrally control an operation of the control circuit 4 and implement various functions of the control circuit 4. In the present embodiment, a case where a processor executes a program stored in a ROM or the like to implement each function of the control circuit 4 will be exemplified, but the present invention is not limited thereto. Part of or all the functions of the control circuit 4 may be implemented by a dedicated hardware circuit (a semiconductor integrated circuit or the like).

As a memory of the control circuit 4, a read only memory (ROM) and a random access memory (RAM) can be used. The ROM of the control circuit 4 is a nonvolatile memory and stores various types of information such as programs and parameters executed by the processor of the control circuit 4. The RAM of the control circuit 4 is a volatile memory that has a working area of the processor. The memory of the control circuit 4 is not limited to the ROM and the RAM, and various recording media and recording devices such as a hard disk drive (HDD), a solid state drive (SSD), and a flash memory may be further used.

The control circuit 4 may be implemented by an electronic control unit (ECU) provided inside the vehicle 2, a domain control unit (DCU) such as a cockpit domain controller (CDC) in which a plurality of ECUs are integrated, or a computer such as an on board unit (OBU).

The control circuit 4 may transmit and receive information to and from another ECU provided in the vehicle 2 or an external power supply (the AC power supply 9) connected to the vehicle 2 via an in-vehicle network including a controller area network (CAN), an Ethernet (registered trademark), a universal serial bus (USB (registered trademark)), or the like in the vehicle 2, or may communicate with an information processing device outside of the vehicle 2 via a network such as the Internet.

The control circuit 4 controls operations of the phase switching circuit 5 and the power conversion circuit 6. In one example, the control circuit 4 implements various functions of the control circuit 4 including a switching control function and a conversion control function by loading the program stored in the ROM (memory) or the like onto the RAM (memory) and causing the processor to execute the loaded program.

The switching control function of the control circuit 4 controls the operations of the phase switching circuit 5 and the power conversion circuit 6.

In one example, the switching control function serves to determine a phase of the external power supply connected to the power conversion device 3. For example, the switching control function determines whether the external power supply connected to the power conversion device 3 is a single phase or a multi-phase, on the basis of an output (read value) of a voltage sensor (not illustrated) that is configured to measure a voltage value applied to the input terminal 301, namely, applied to the power supply lines L1 to L3 and N.

In one example, when the single-phase AC power supply 9a is connected to the power conversion device 3, the switching control function serves to turn on the predetermined MOSFET 61 at a predetermined timing.

The predetermined timing is, for example, a timing when the power supply voltage from the single-phase AC power supply 9a is at a “negative” peak. In such a case, the switching control function serves to turn on the MOSFETs 61c and 61e. Specifically, the switching control function serves to generate a control signal for turning on each switch of the MOSFETs 61c and 61e and supplies the generated control signal to the MOSFETs 61c and 61e when the power supply voltage is at the “negative” peak.

The predetermined timing is, for example, a timing when the power supply voltage from the single-phase AC power supply 9a is at a “positive” peak. In such a case, the switching control function serves to turn on the MOSFETs 61d and 61f. Specifically, the switching control function serves to generate a control signal for turning on each switch of the MOSFETs 61d and 61f and supplies the generated control signal to the MOSFETs 61d and 61f when the power supply voltage is at the “positive” peak.

In one example, the switching control function serves to detect a voltage between contact points of the relay circuit 51 after the predetermined MOSFET 61 is turned on at the predetermined timing, and determine a zero-crossing point (ZCP) of the power supply voltage at which the voltage between the contact points becomes zero or substantially zero. In other words, in a state where the predetermined MOSFET 61 is turned on, the switching control function detects the zero-crossing point at which the power supply voltage from the single-phase AC power supply 9a zero-crosses, based on the voltage between the contact points of the relay circuit 51. The voltage between the contact points of the relay circuit 51a indicates a potential difference between the power supply lines L1 and L2. Similarly, the voltage between the contact points of the relay circuit 51b indicates a potential difference between the power supply lines L1 and L3. The voltage between the contact points being substantially zero means that the voltage between the contact points is a voltage (potential difference) within a threshold range set in advance and stored in a memory or the like as a voltage (potential difference) that can be regarded as zero, for example. Hereinafter, when simply describing a case of zero, a case of substantially zero is included.

In one example, the switching control function serves to switch between short-circuit and opening by the relay circuit 51 in a predetermined period of time following the zero-crossing point (in the present disclosure, referred to as a zero period) after the predetermined MOSFET 61 is turned on. The zero period that is a predetermined period of time following the zero-crossing point is, for example, a period of about ¼ cycles of the power supply voltage. A time width of the zero period may vary with a circuit configuration of the power conversion device 3 such as capacitance of an electrolytic capacitor 69 and an amount of accumulated charges.

In one example, the zero period is a period of time during which the voltage between the contact points of the relay circuit 51 is within a predetermined threshold range starting from the zero-crossing point. The threshold range is determined in advance and stored in the memory or the like of the control circuit 4. The threshold range is based on a range of substantially zero in which the voltage between the contact points of the relay circuit 51 can be regarded as zero.

In one example, the zero period is a period of time during which an increase amount of the power supply voltage is “positive” after passing though the zero-crossing point at which the voltage between the contact points of the relay circuit 51 becomes zero after the MOSFETs 61c and 61e are turned on when the power supply voltage from the single-phase AC power supply 9a is at a “negative” peak.

In one example, the zero period is a period of time during which an increase amount of the power supply voltage is “negative” after passing though the zero-crossing point at which the voltage between the contact points of the relay circuit 51a (a potential difference between power supply lines L1 and L2) becomes zero after the MOSFETs 61d and 61f are turned on when the power supply voltage from the single-phase AC power supply 9a is at a “positive” peak.

In the zero period, the switching control function serves to operate the relay circuit 51a to short-circuit between the power supply lines L1 and L2. Specifically, in the zero period, the switching control function serves to operate the relay circuit 51a to generate a control signal for switching short-circuit and opening between the power supply lines L1 and L2, and supplies the generated control signal to the relay circuit 51a. Moreover, in the zero period, the switching control function serves to operate the relay circuit 51b to short-circuit between the power supply lines L1 and L3. Specifically, the switching control function serves to operate the relay circuit 51b to generate a control signal for switching short-circuit and opening between the power supply lines L1 and L3, and supplies the generated control signal to the relay circuit 51b.

In one example, the switching control function serves to turn off the predetermined MOSFET 61 that was turned on at a predetermined timing immediately after short-circuiting between the power supply lines L1 and L2 and between the power supply lines L1 and L3.

The predetermined timing is, for example, a timing when the power supply voltage from the single-phase AC power supply 9a is at the “positive” peak immediately after short-circuiting between the power supply lines L1 and L2 and between the power supply lines L1 and L3 in the zero period after the MOSFETs 61c and 61e are turned on while the power supply voltage from the single-phase AC power supply 9a is at the “negative” peak. In such a case, the switching control function serves to turn off the MOSFETs 61c and 61e. Specifically, the switching control function serves to generate a control signal for turning off each switch of the MOSFETs 61c and 61e and supplies the generated control signal to the MOSFETs 61c and 61e at the predetermined timing.

The predetermined timing is, for example, a timing when the power supply voltage from the single-phase AC power supply 9a is at the “negative” peak immediately after short-circuiting between the power supply lines L1 and L2 and between the power supply lines L1 and L3 during the zero period after the MOSFETs 61d and 61f are turned on while the power supply voltage from the single-phase AC power supply 9a is at the “positive” peak. In such a case, the switching control function serves to turn off the MOSFETs 61d and 61f. Specifically, the switching control function serves to generate a control signal for turning off each switch of the MOSFETs 61d and 61f and supplies the generated control signal to the MOSFETs 61d and 61f at the predetermined timing.

The conversion control function of the control circuit 4 serves to control the operation of the power conversion circuit 6.

In one example, the conversion control function serves to start power conversion for rectifying (converting) AC power from the single-phase AC power supply 9a into DC power at an optional timing after the predetermined MOSFET 61 that was turned on by the switching control function is turned off.

In one example, the conversion control function serves to generate a control signal for turning on or off each switch of the MOSFETs 61 so that a DC voltage having a desired voltage value can be output by using the input AC power, and supplies the generated control signal to the MOSFETs 61.

The control circuit 4 that implements the switching control function and the control circuit 4 that implements the conversion control function may be implemented as independent circuits. The control circuit 4 that controls the operation of the phase switching circuit 5 and the control circuit 4 that controls the operation of the power conversion circuit 6 may be implemented as independent circuits.

As illustrated in FIG. 2, the phase switching circuit 5 includes two relay circuits 51a and 51b.

The relay circuit 51 is, for example, a single-pole double-throw (SPDT) switch circuit. The relay circuit 51 is an example of a circuit capable of switching a connection destination of a pair of power semiconductor devices corresponding to another phase different from a specific phase among three phases of the three-phase AC power supply 9b between the specific phase and the other phase.

One input end of a pair of input ends of the relay circuit 51a is electrically connected between the input terminal 301a and an inrush protection resistor 65a in the power supply line L1. The other input end is electrically connected to the input terminal 301b via the power supply line L2. The output end of the relay circuit 51a is electrically connected to an inrush protection resistor 65b via the power supply line L2.

One of the pair of input ends of the relay circuit 51b is electrically connected between the input terminal 301a and the inrush protection resistor 65a in the power supply line L1. The other input end is electrically connected to the input terminal 301c via the power supply line L3. The output end of the relay circuit 51b is electrically connected to an inrush protection resistor 65c via the power supply line L3.

The relay circuit 51a switches a phase of the AC power supply supplied to the power supply line L2 between, for example, a V-phase (second phase) corresponding to the power supply line L2 and a single phase common to the power supply lines L1 to L3, in accordance with a control signal input from the control circuit 4. Specifically, the relay circuit 51a switches a connection destination of the power supply line L2 electrically connected to the MOSFETs 61c and 61d of the power conversion circuit 6 between the power supply line L2 electrically connected to the input terminal 301b and the power supply line L1 electrically connected to the input terminal 301a, in accordance with the control signal input from the control circuit 4. Thus, the relay circuit 51a switches short-circuit and opening between the power supply lines L1 and L2 in accordance with the control signal input from the control circuit 4.

The relay circuit 51b switches a phase of the AC power supply supplied to the power supply line L3 between, for example, a W-phase (third phase) corresponding to the power supply line L3 and the single phase common to the power supply lines L1 to L3, in accordance with a control signal input from the control circuit 4. Specifically, the relay circuit 51b switches a connection destination of the power supply line L3 electrically connected to the MOSFETs 61e and 61f of the power conversion circuit 6 between the power supply line L3 electrically connected to the input terminal 301c and the power supply line L1 electrically connected to the input terminal 301a, in accordance with the control signal input from the control circuit 4. Thus, the relay circuit 51b switches short-circuit and opening between the power supply lines L1 and L3 in accordance with the control signal input from the control circuit 4.

The control signal supplied to the relay circuit 51 is, for example, a signal indicating a connection state of the relay circuit 51 and is a rectangular wave signal having a binary value of a high level or a low level. The relay circuit 51 is not limited to a mechanical switching unit, and may be configured with a semiconductor switching element.

As illustrated in FIG. 2, the power conversion circuit 6 includes MOSFETs 61a, 61c, 61e, and 61g that are located on the high side, MOSFETs 61b, 61d, 61f, and 61h that are located on the low side, three capacitors 63a to 63c, three inrush protection resistors 65a to 65c, three coils 67a to 67c, and an electrolytic capacitor 69. Note that the MOSFETs 61a to 61h are examples of multiple power semiconductor devices included in the power conversion circuit.

A simple equivalent circuit of the MOSFET 61 can be configured by using, for example, a switch, a capacitor, and a diode, and operates in accordance with a control signal from the control circuit 4. In such a simple equivalent circuit, the switch, the capacitor, and the diode are electrically connected in parallel. In the MOSFET 61 on the high side, an anode and a cathode of the diode are electrically connected to the input side (the input terminal 301 side) and the output side (the output terminal 302 side) of each MOSFET 61, respectively. On the other hand, in the MOSFET 61 on the low side, the anode and the cathode of the diode are electrically connected to the output side and the input side of each MOSFET 61, respectively. The switch is turned on or off at a timing corresponding to a control signal from the control circuit 4 to switch conduction or communication thereof. In each MOSFET 61, charges from the AC power supply are accumulated in the capacitor in a period of time during which the switch is turned off (communicated), and a potential difference is generated between terminals on the input side and the output side. In the present embodiment, turning on/off the internal switch is expressed as turning on/off the MOSFET 61.

The MOSFETs 61a and 61b are examples of a pair of power semiconductor devices that is related to the power supply line L1, namely, that corresponds to a specific phase among multiple phases of the three-phase AC power supply 9b. When the single-phase AC power supply 9a is connected to the power conversion device 3, the MOSFETs 61g and 61h in addition to the MOSFETs 61a and 61b may constitute a first power conversion circuit. The input sides of the MOSFETs 61a and 61b are electrically connected, and the power supply line L1 is connected between the MOSFETs 61a and 61b. The side of the MOSFET 61a opposite to the MOSFET 61b (output side) is electrically connected to the output terminal 302a. The side of the MOSFET 61b opposite to the MOSFET 61a (output side) is electrically connected to the output terminal 302b. Specifically, the MOSFETs 61a and 61b rectify a single-phase current flowing through the power supply line L1 from the single-phase AC power supply 9a. Alternatively, the MOSFETs 61a and 61b rectify, for example, the U-phase (first phase) current flowing through the power supply line L1 from the three-phase AC power supply 9b.

The MOSFETs 61c and 61d are examples of a pair of power semiconductor devices that is related to the power supply line L2, namely, that corresponds to another phase different from the specific phase among multiple of phases of the three-phase AC power supply 9b. When the single-phase AC power supply 9a is connected to the power conversion device 3, the MOSFETs 61g and 61h in addition to the MOSFETs 61c and 61d may constitute a second power conversion circuit. The input sides of the MOSFETs 61c and 61d are electrically connected, and the power supply line L2 is connected between the MOSFETs 61c and 61d. The side of the MOSFET 61c opposite to the MOSFET 61d (output side) is electrically connected to the output terminal 302a. The side of the MOSFET 61d opposite to the MOSFET 61c (output side) is electrically connected to the output terminal 302b. Specifically, the MOSFETs 61c and 61d rectify a single-phase current flowing through the power supply line L2 from the single-phase AC power supply 9a. Alternatively, the MOSFETs 61c and 61d rectify, for example, the V-phase (second phase) current flowing through the power supply line L2 from the three-phase AC power supply 9b.

The MOSFETs 61e and 61f are examples of a pair of power semiconductor devices that is related to the power supply line L3, namely, that corresponds to another phase different from the specific phase among multiple phases of the three-phase AC power supply 9b. When the single-phase AC power supply 9a is connected to the power conversion device 3, the MOSFETs 61g and 61h in addition to the MOSFETs 61e and 61f may constitute a third power conversion circuit. The input sides of the MOSFETs 61e and 61f are electrically connected, and a power supply line L3 is connected between the MOSFETs 61e and 61f. The side of the MOSFET 61e opposite to the MOSFET 61f (output side) is electrically connected to the output terminal 302a. The side of the MOSFET 61f opposite to the MOSFET 61e (output side) is electrically connected to the output terminal 302b. Specifically, the MOSFETs 61e and 61f rectify a single-phase current flowing through the power supply line L3 from the single-phase AC power supply 9a. Alternatively, the MOSFETs 61c and 61d rectify, for example, the W-phase (third phase) current flowing through the power supply line L3 from the three-phase AC power supply 9b.

The MOSFETs 61g and 61h are examples of a pair of power semiconductor devices that is related to the power supply line N, namely, that corresponds to a neutral power supply line. The input sides of the MOSFETs 61g and 61h are electrically connected, and the power supply line N is connected between the MOSFETs 61g and 61h. The side of the MOSFET 61g opposite to the MOSFET 61h (output side) is electrically connected to the output terminal 302a. The side of the MOSFET 61h opposite to the MOSFET 61g (output side) is electrically connected to the output terminal 302b. Specifically, the MOSFETs 61g and 61h form an electrical path for returning single-phase currents flowing through the power supply lines L1 to L3 from the single-phase AC power supply 9a to the AC power supply 9 side.

The capacitor 63 is an X capacitor connected between power supply lines (between lines). For example, the capacitor 63a is an X capacitor electrically connected between the power supply lines L1 and N. For example, the capacitor 63b is an X capacitor connected between the power supply lines L2 and N. For example, the capacitor 63c is an X capacitor connected between the power supply lines L3 and N. One end of each of the capacitors 63a to 63c is electrically connected between each of the MOSFETs 61g and 61h and the input terminal 301d in the power supply line N. The other end of the capacitor 63a is electrically connected between a connection node with the relay circuit 51a and the inrush protection resistor 65a in the power supply line L1. The other end of the capacitor 63b is electrically connected between the output end of the relay circuit 51a and the inrush protection resistor 65b in the power supply line L2. The other end of the capacitor 63c is electrically connected between the output end of the relay circuit 51b and the inrush protection resistor 65c in the power supply line L3.

The inrush protection resistor 65 is an inrush current preventing element such as a temperature fuse resistor, a cement resistor, or a thermistor. The inrush protection resistor 65 inhibits an inrush current from flowing to the power conversion circuit 6. The inrush protection resistor 65a is electrically connected between a connection node with the capacitor 63a and the coil 67a in the power supply line L1. The inrush protection resistor 65b is electrically connected between a connection node with the capacitor 63b and the coil 67b in the power supply line L2. The inrush protection resistor 65c is electrically connected between a connection node with the capacitor 63c and the coil 67c in the power supply line L3. In the power conversion device 3, the inrush protection resistor 65 is not an essential configuration, and may not be provided. In the phase switching circuit 5, when, for example, the relay circuit 51a connects the coil 67b and the input terminal 301b in the power supply line L2 by default or when the relay circuit 51b connects the coil 67c and the input terminal 301c in the power supply line L3 by default, the inrush protection resistor 65 may not be provided.

The coil 67 is a common mode choke coil, a normal mode choke coil, or the like. The coil 67a is electrically connected between the inrush protection resistor 65a and each of the MOSFETs 61a and 61b in the power supply line L1. The coil 67b is electrically connected between the inrush protection resistor 65b and each of the MOSFETs 61c and 61d in the power supply line L2. The coil 67c is electrically connected between the inrush protection resistor 65c and each of the MOSFETs 61e and 61f in the power supply line L3.

The capacitor 63 and the coil 67 form a noise filter. The noise filter (eliminates noise) inhibits inflow of noise from the AC power supply 9 to the power conversion circuit 6 and outflow of noise from the power conversion circuit 6 to the AC power supply 9. For example, the capacitor 63a and the coil 67a are noise filters provided in the power supply line L1. For example, the capacitor 63b and the coil 67b are noise filters provided in the power supply line L2. For example, the capacitor 63c and the coil 67c are noise filters provided in the power supply line L3.

The electrolytic capacitor 69 is electrically connected between the output terminals 302a and 302b, namely, between a pair of power supply lines for output.

Next, an operation example of the power conversion device 3 configured as described above will be described.

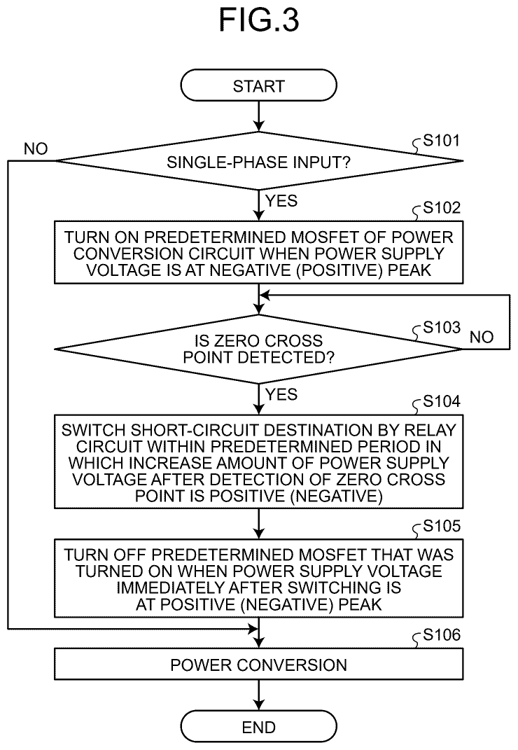

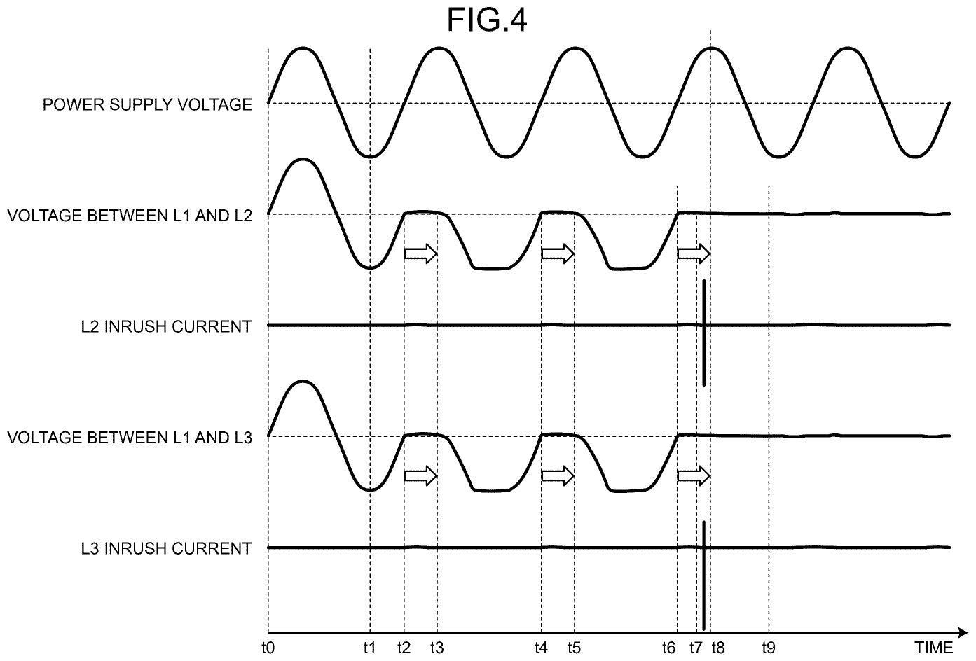

FIG. 3 is a flowchart illustrating an example of a procedure of control processing executed by the control circuit 4 of FIG. 2. The procedure of FIG. 3 starts at a time when an external power supply (the single-phase AC power supply 9a or the three-phase AC power supply 9b) is connected to the power conversion device 3. FIG. 4 is a timing chart illustrating an operation timing of each unit of the power conversion device 3 by the control circuit 4 of FIG. 2.

The control circuit 4 determines whether an input is a single-phase input (S101).

In the example of FIG. 4, at “t0”, the control circuit 4 determines whether the AC power input to the power conversion device 3 is AC power with a single phase.

In response to determining that the input is a single-phase input (S101: Yes), the control circuit 4 turns on the predetermined MOSFET 61 of the power conversion circuit 6 when the power supply voltage is at a “negative (positive)” peak (S102).

In the example of FIG. 4, the control circuit 4 turns on the MOSFETs 61c and 61e at “t1” at which the power supply voltage of the single-phase input reaches a “negative” peak.

After the predetermined MOSFET 61 is turned on, the control circuit 4 detects the voltage between the contact points of the relay circuit 51, and determines whether the zero-crossing point is detected based on the detected voltage between the contact points (S103). When the zero-crossing point is not detected (S103: No), the processing of S103 is repeated at a predetermined cycle until the zero-crossing point is detected. Conversely, when the zero-crossing point is detected (S103: Yes), the control circuit 4 causes the relay circuit 51 to switch a short-circuit destination within a predetermined period of time during which the increase amount of the power supply voltage is “positive (negative)” after the detection of the zero-crossing point, namely, within the zero period (S104).

In the example of FIG. 4, the zero-crossing point is detected at “t6”. In this case, at “t7” within the zero period “t6 to t8” during which the increase amount of the power supply voltage after the zero-crossing point of “t6” is “positive”, the control circuit 4 causes the relay circuit 51 to switch the short-circuit destination and short-circuits between the power supply lines L1 and L2 and between the power supply lines L1 and L3.

Note that, if the zero-crossing point is detected at “t2”, the control circuit 4 causes the relay circuit 51 to switch the short-circuit destination within a zero period “t2 to t3” after the zero-crossing point at “t2”. If the zero-crossing point is detected at “t4”, the control circuit 4 causes the relay circuit 51 to switch the short-circuit destination within a zero period “t4 to t5” after the zero-crossing point at “t4”.

When the short-circuit destination is switched by the relay circuit 51 within the zero period during which the increase amount of the power supply voltage is “positive (negative)” and the power supply voltage immediately after switching is at the “positive (negative)” peak, the control circuit 4 turns off the MOSFET 61 that was turned on in the processing of S102 (S105).

In the example of FIG. 4, the control circuit 4 turns off the MOSFETs 61c and 61e at “t8”, which were turned on at “t1” at “t8”. The “t8” is a timing at which the power supply voltage reaches a “positive” peak immediately after short-circuit is performed between the power supply lines L1 and L2 and between the power supply lines L1 and L3 at “t7”.

After the processing of S101 or S106, the control circuit 4 executes power conversion (S106).

In the example of FIG. 4, the control circuit 4 starts power conversion at “t9” that is an optional timing after the MOSFETs 61c and 61e that were turned on at “t1” are turned off at “t8”.

In a case where the single-phase AC power from the single-phase AC power supply 9a is input to the power conversion device 3, each of the relay circuits 51a and 51b is short-circuited to the power supply line L1. Therefore, the single-phase AC current flowing through the power supply line L1 is supplied to the MOSFETs 61a and 61b via the coil 67a, is distributed to the coils 67b and 67c by the relay circuits 51a and 51b, and is supplied to the MOSFETs 61c and 61d and the MOSFETs 61e and 61f, respectively. Accordingly, even when the connected external power supply is the single-phase AC power supply 9a, a plurality of sets of MOSFETs 61 with a small rated capacity can be used, and thus a rated capacity of the entire power conversion device 3 can be increased.

In a case where three-phase AC power from the three-phase AC power supply 9b is input to the power conversion device 3, the relay circuits 51a and 51b are in contact with the power supply lines L2 and L3. Therefore, the first-phase AC current flowing through the power supply line L1 is supplied to the MOSFETs 61a and 61b via the coil 67a, the second-phase AC current flowing through the power supply line L2 is supplied to the MOSFETs 61c and 61d via the coil 67b, and the third-phase AC current flowing through the power supply line L3 is supplied to the MOSFETs 61e and 61f via the coil 67c. Accordingly, the rated capacity of the entire power conversion device 3 can be further increased by using the set of MOSFETs 61 provided for each phase.

In the related art, there has been a case where a connection destination of a relay circuit is actually switched at a timing deviated from a zero-crossing point due to a variation in a circuit and a component, a change in an external environment, or the zero-crossing point being an instantaneous timing. When the connection destination of the relay circuit is switched at a timing deviated from the zero-crossing point, the connection destination of the relay circuit is switched at a timing at which a voltage between contact points of the relay circuit is not zero. Therefore, there has been a problem that an inrush current flows from an AC power supply to an X capacitor via the relay circuit, and the relay circuit is fixed. Therefore, there is room for improvement with regard to inhibition of an inrush current generated in a relay circuit during phase switching of an input AC power supply.

Under such circumstances, the power conversion device 3 according to the embodiment is compliant to the single-phase AC power supply and the multi-phase AC power supply, and is configured such that a short-circuit destination by the relay circuit 51 is switched while the predetermined MOSFET 61, namely, part of power semiconductor devices is temporarily turned on at a predetermined timing based on a waveform of a power supply voltage in the case of a single-phase input.

According to this configuration, the zero period during which the voltage between the contact points of the relay circuit 51 becomes zero can be formed by using the zero-crossing point as a starting point of the zero period. According to the above-described configuration, the relay circuit 51 is switched during the zero period following the zero-crossing point of a power supply voltage at which the voltage between the contact points of the relay circuit 51 becomes zero. Therefore, an inrush current can be inhibited. In other words, according to the above configuration, an inrush current generated in a mechanical relay (the relay circuit 51) during phase switching of the AC power supply can be inhibited by combining a switching operation of a power semiconductor device. Since an inrush current can be inhibited by combining the switching operation of the power semiconductor device, namely, without newly adding components, it is possible to maintain low cost and space saving.

In the above-described embodiment, the wording of “determining whether it is A” may be interpreted as “determining that it is A”, “determining that it is not A”, or “determining whether or not it is A”.

A computer program executed by the control circuit 4 of the power conversion device 3 according to the above-described embodiment may be provided to be incorporated in advance in a memory such as a ROM.

Additionally, the computer program executed by the control circuit 4 of the power conversion device 3 according to the above-described embodiment may be provided by being recorded in a computer-readable recording medium such as a CD-ROM, an FD, a CD-R, a DVD, and an SD card as a file in an installable format or an executable format.

The program executed by the control circuit 4 of the power conversion device 3 of the above-described embodiment may be stored on a computer connected to a network such as the Internet and provided by being downloaded via the network. A program executed by the control circuit 4 of the power conversion device 3 may be provided or distributed via a network such as the Internet.

The program executed by the control circuit 4 of the power conversion device 3 according to the above-described embodiment may be configured as a module including each functional unit that implements each of the above-described functions, and a processor such as a CPU that is actual hardware may read a program from a memory such as a ROM and execute the program such that each functional unit is loaded onto a RAM and each functional unit is generated on the RAM.

According to at least one of the above-described embodiments, it is possible to inhibit an inrush current generated in the relay circuit during phase switching of the input AC power supply.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### (Supplementary Note)

The following technique is disclosed by the above description of the embodiments.

### (Supplementary Note 1)

1. A Power Conversion Device Comprising:
a plurality of terminals to which a single-phase AC power supply or a multi-phase AC power supply is connected as an external power supply;
a power conversion circuit including multiple power semiconductor devices, the multiple power semiconductor devices including a first pair of power semiconductor devices and a second pair of power semiconductor devices, the first pair of power semiconductor devices corresponding to a specific phase of the multiple phases of the multi-phase AC power supply, the second pair of power semiconductor devices corresponding to another phase different from the specific phase of the multiple phases;
a phase switching circuit including a relay circuit configured to switch a connection destination of the second pair of power semiconductor devices between the specific phase and the other phase; and
a control circuit configured to control operations of the power conversion circuit and the phase switching circuit, the control being performed by, when the single-phase AC power supply is connected to the terminals,
   turning on a predetermined power semiconductor device among the multiple power semiconductor devices,
   detecting a zero-crossing point at which a power supply voltage from the single-phase AC power supply zero-crosses in a state where the predetermined power semiconductor device is turned on, the zero-crossing point being detected based on a voltage between contact points of the relay circuit, and
   switching a connection destination of the second pair of power semiconductor devices to the specific phase by operating the relay circuit within a zero period following the zero-crossing point.

### (Supplementary Note 2)

The power conversion device according to the supplementary note 1, wherein the control circuit is configured to turn on the predetermined power semiconductor device located on a high side among the multiple power semiconductor devices, the turning on being performed when the power supply voltage from the single-phase AC power supply is at a negative peak.

### (Supplementary Note 3)

The power conversion device according to the supplementary note 2, wherein the zero period is a period of time during which an increase amount of the power supply voltage from the single-phase AC power supply is positive after the predetermined power semiconductor device on the high side is turned on.

### (Supplementary Note 4)

The power conversion device according to the supplementary note 2 or 3, wherein the control circuit is configured to turn off the predetermined power semiconductor device on the high side having been turned on, the turning off being performed when the power supply voltage from the single-phase AC power supply is at a positive peak immediately after the relay circuit is operated in the zero period.

### (Supplementary Note 5)

The power conversion device according to the supplementary note 1, wherein the control circuit is configured to turn on the predetermined power semiconductor device located on a low side among the multiple power semiconductor devices, the turning on being performed when the power supply voltage from the single-phase AC power supply is at a positive peak.

### (Supplementary Note 6)

The power conversion device according to the supplementary note 5, wherein the zero period is a period of time during which an increase amount of the power supply voltage from the single-phase AC power supply is negative after the predetermined power semiconductor device on the low side is turned on.

### (Supplementary Note 7)

The power conversion device according to the supplementary note 5 or 6, wherein the control circuit is configured to turn off the predetermined power semiconductor device on the low side having been turned on, the turning off being performed when the power supply voltage from the single-phase AC power supply is at a negative peak immediately after the relay circuit is operated in the zero period.

### (Supplementary Note 8)

The power conversion device according to any one of the supplementary notes 1 to 7, wherein the zero period is a period of time during which a voltage between contact points of the relay circuit is within a predetermined threshold range starting from the zero-crossing point.

### (Supplementary Note 9)

The Power Conversion Device According to any One of the Supplementary Notes 1 to 8, Wherein the Control Circuit is Configured to,
after the relay circuit is operated in the zero period, turn off the predetermined power semiconductor device having been turned on, and
start power conversion to convert AC power from the single-phase AC power supply into DC power after the predetermined power semiconductor device is turned off.

### (Supplementary Note 10)

A method of controlling a power conversion device including a plurality of terminals to which a single-phase AC power supply or a multi-phase AC power supply is connected as an external power supply, a power conversion circuit including multiple power semiconductor devices, the multiple power semiconductor devices including a first pair of power semiconductor devices and a second pair of power semiconductor devices, the first pair of power semiconductor devices corresponding to a specific phase of the multiple phases of the multi-phase AC power supply, the second pair of power semiconductor devices corresponding to another phase different from the specific phase of the multiple phases, a phase switching circuit including a relay circuit configured to switch a connection destination of the second pair of power semiconductor devices between the specific phase and the other phase, and a control circuit configured to control operations of the power conversion circuit and the phase switching circuit, the method comprising:
when the single-phase AC power supply is connected to the terminals,
   turning on a predetermined power semiconductor device among the multiple power semiconductor devices,
   detecting a zero-crossing point at which a power supply voltage from the single-phase AC power supply zero-crosses in a state where the predetermined power semiconductor device is turned on, the zero-crossing point being detected based on a voltage between contact points of the relay circuit, and
   switching a connection destination of the second pair of power semiconductor devices to the specific phase by operating the relay circuit within a zero period following the zero-crossing point.

### (Supplementary Note 11)

The method of controlling the power conversion device according to the supplementary note 10, further comprising turning on the predetermined power semiconductor device located on a high side among the multiple power semiconductor devices, the turning on being performed when the power supply voltage from the single-phase AC power supply is at a negative peak.

### (Supplementary Note 12)

The method of controlling the power conversion device according to the supplementary note 11, wherein the zero period is a period of time during which an increase amount of the power supply voltage from the single-phase AC power supply is positive after the predetermined power semiconductor device on the high side is turned on.

### (Supplementary Note 13)

The method of controlling the power conversion device according to the supplementary note 11 or 12, further comprising turning off the predetermined power semiconductor device on the high side having been turned on, the turning off being performed when the power supply voltage from the single-phase AC power supply is at a positive peak immediately after the relay circuit is operated in the zero period.

### (Supplementary Note 14)

The method of controlling the power conversion device according to supplementary note 10, further comprising turning on the predetermined power semiconductor device located on a low side among the multiple power semiconductor devices, the turning on being performed when the power supply voltage from the single-phase AC power supply is at a positive peak.

### (Supplementary Note 15)

The method of controlling the power conversion device according to the supplementary note 14, wherein the zero period is a period of time during which an increase amount of the power supply voltage from the single-phase AC power supply is negative after the predetermined power semiconductor device on the low side is turned on.

### (Supplementary Note 16)

The method of controlling the power conversion device according to the supplementary note 14 or 15, further comprising turning off the predetermined power semiconductor device on the low side having been turned on, the turning off being performed when the power supply voltage from the single-phase AC power supply is at a negative peak immediately after the relay circuit is operated in the zero period.

### (Supplementary Note 17)

The method of controlling the power conversion device according to any one of the supplementary notes 10 to 16, wherein the zero period is a period of time during which a voltage between contact points of the relay circuit is within a predetermined threshold range starting from the zero-crossing point.

### (Supplementary Note 18)

The Method of Controlling the Power Conversion Device According to any One of the Supplementary Notes 10 to 17, Further Comprising:
after the relay circuit is operated in the zero period, turning off the predetermined power semiconductor device having been turned on; and
starting power conversion to convert AC power from the single-phase AC power supply into DC power after the predetermined power semiconductor device is turned off.

### (Supplementary Note 19)

A power conversion device including:
one or more processors; and
a memory in which one or more computer programs executed by the one or more processors are stores,
wherein the one or more processors is configured to implement the method of controlling the power conversion device according to any one of the supplementary notes 10 to 18 by executing the one or more computer programs.

### (Supplementary Note 20)

A computer program instructing a computer to execute the method of controlling the power conversion device according to any one of the supplementary notes 10 to 18.

### (Supplementary Note 21)

A computer program product comprising a recording medium on which a computer program according to the supplementary note 20 is recorded.

### (Supplementary Note 22)

A vehicle comprising:
the power conversion device according to any one of the supplementary notes 1 to 9 and the supplementary note 19 configured to convert AC power from an external AC power supply into DC power; and
a battery to be charged by using the DC power converted by the power conversion device.

What is claimed is:

1. A power conversion device comprising:
a plurality of terminals to which a single-phase AC power supply or a multi-phase AC power supply is connected as an external power supply;
a power conversion circuit including multiple power semiconductor devices, the multiple power semiconductor devices including a first pair of power semiconductor devices and a second pair of power semiconductor devices, the first pair of power semiconductor devices corresponding to a specific phase of the multiple phases of the multi-phase AC power supply, the second pair of power semiconductor devices corresponding to another phase different from the specific phase of the multiple phases;
a phase switching circuit including a relay circuit configured to switch a connection destination of the second pair of power semiconductor devices between the specific phase and the other phase; and
a control circuit configured to control operations of the power conversion circuit and the phase switching circuit, the control being performed by, when the single-phase AC power supply is connected to the terminals,
turning on a predetermined power semiconductor device among the multiple power semiconductor devices,
detecting a zero-crossing point at which a power supply voltage from the single-phase AC power supply zero-crosses in a state where the predetermined power semiconductor device is turned on, the zero-crossing point being detected based on a voltage between contact points of the relay circuit, and
switching a connection destination of the second pair of power semiconductor devices to the specific phase by operating the relay circuit within a zero period following the zero-crossing point.

2. The power conversion device according to claim 1, wherein the control circuit is configured to turn on the predetermined power semiconductor device located on a high side among the multiple power semiconductor devices, the turning on being performed when the power supply voltage from the single-phase AC power supply is at a negative peak.

3. The power conversion device according to claim 2, wherein the zero period is a period of time during which an increase amount of the power supply voltage from the single-phase AC power supply is positive after the predetermined power semiconductor device on the high side is turned on.

4. The power conversion device according to claim 2, wherein the control circuit is configured to turn off the predetermined power semiconductor device on the high side having been turned on, the turning off being performed when the power supply voltage from the single-phase AC power supply is at a positive peak immediately after the relay circuit is operated in the zero period.

5. The power conversion device according to claim 3, wherein the control circuit is configured to turn off the predetermined power semiconductor device on the high side having been turned on, the turning off being performed when the power supply voltage from the single-phase AC power supply is at a positive peak immediately after the relay circuit is operated in the zero period.

6. The power conversion device according to claim 1, wherein the control circuit is configured to turn on the predetermined power semiconductor device located on a low side among the multiple power semiconductor devices, the turning on being performed when the power supply voltage from the single-phase AC power supply is at a positive peak.

7. The power conversion device according to claim 6, wherein the zero period is a period of time during which an increase amount of the power supply voltage from the single-phase AC power supply is negative after the predetermined power semiconductor device on the low side is turned on.

8. The power conversion device according to claim 6, wherein the control circuit is configured to turn off the predetermined power semiconductor device on the low side having been turned on, the turning off being performed when the power supply voltage from the single-phase AC power supply is at a negative peak immediately after the relay circuit is operated in the zero period.

9. The power conversion device according to claim 7, wherein the control circuit is configured to turn off the predetermined power semiconductor device on the low side having been turned on, the turning off being performed when the power supply voltage from the single-phase AC power supply is at a negative peak immediately after the relay circuit is operated in the zero period.

10. The power conversion device according to claim 1, wherein the zero period is a period of time during which a voltage between contact points of the relay circuit is within a predetermined threshold range starting from the zero-crossing point.

11. The power conversion device according to claim 1, wherein the control circuit is configured to,
after the relay circuit is operated in the zero period, turn off the predetermined power semiconductor device having been turned on, and
start power conversion to convert AC power from the single-phase AC power supply into DC power after the predetermined power semiconductor device is turned off.
